(19) United States
(12) Patent Application Publication
(10) Pub. No.: US 2003/0158970 A1
(43) Pub. Date: Aug. 21, 2003

(54) Method of optimising messaging or data transfer, and a system using such a method

(76) Inventors: Christopher Tofts, Bristol (GB); Athena Christodoulou, Bristol (GB); Richard Taylor, Bristol (GB)

Correspondence Address: HEWLETT-PACKARD COMPANY, Intellectual Property Administration, P.O. Box 272400, Fort Collins, CO, 80527-2400, US

(21) Appl. No.: 10/351,025

(22) Filed: Jan. 24, 2003

(30) Foreign Application Priority Data
Feb. 13, 2002 (GB) 0203362.9

(51) Int. Cl. G06F 15/16

(52) U.S. Cl. 709/246

(57) ABSTRACT

A method and apparatus are provided for automatic analysis of communications paths to remove or modify redundant or inappropriate steps or data processing operators.

In any data communication system, and especially large or complex ones, data may be passed between several devices as it propagates from a source of the data to a target for the data. The present invention relates to a method of modifying the data transmission path and protocols used therein so as to improve data flow.

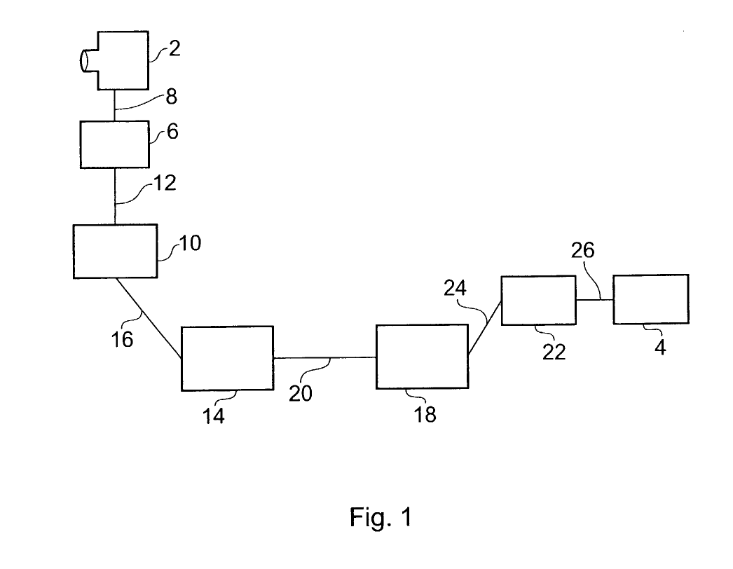

FIG. 1 schematically illustrates an example of a simple data processing system. In this example a camera 2 provides streaming video to a display 4 which is situated remotely from the camera. The camera 2 is connected to a host personal computer 6 via a first communications link 8 which may, for example, be a connection to the USB port of the computer 6. The computer 6 may be on a local area network and may connect to its local server 10 across local area network 12 using the local area network protocols. The local server 10 may then connect to an Internet service provider 14 using a communication link 16, such as an ISDN link. The Internet service provider 14 may then connect to a further service provider 18 via a communications link 20. The second service provider 20 may then connect with a user's server 22 via, for example, a second ISDN link 24 and the server 22 then connects to the user's device 4 via a further communication link 26.

Conventionally, at each link in the chain, the data is likely to be transformed from one format to another format in order to adhere to defined communications protocols. The data pathway is not completely static, as the devices along it will negotiate in order to find a standard at which they can transmit data from one to another. This inevitably means that the speed of data transmission becomes matched to that of the slowest device. However these negotiations are made on a device to device basis and do not include any knowledge of the global system or the task that it is seeking to perform. Thus, the camera 2 may be producing streaming video at 24 frames per second and full colour, whereas the user device 4 may for example be a personal digital assistant having a monochrome screen connected to the server via an infrared link. If the camera and other devices towards the data source end of the transmission chain had knowledge that the target display device could only handle monochrome, then the camera and the other devices could adjust their operation so as to make better use of the resources within the transmission path. Thus, the camera could immediately switch to a monochrome mode thereby significantly reducing the amount of data which it is attempting to send. It could then compensate by possibly improving its frame rate such that the user received a better service as a result of the optimised network. Furthermore, such an optimised data path minimises its impact on resources, memory and devices within the pathway. This is significant as many of these devices will be multi-tasking and hence will also be performing tasks for other users. Thus, it will be possible by sharing system information around the system to reduce the workload on various devices within the data path, thereby improving their performance with regards to other users, and possibly also to enhancing the performance seen by the user in this particular pathway.

According to a first aspect of the present invention, there is provided a method of transferring data between a source entity and a target entity via a data pathway, each entity having a hierarchy of communication processing layers implementing at least one communications protocol, the method comprising the steps of determining the capabilities of the entities, analysing the capabilities of the entities, and on the basis of those capabilities establishing a communication scheme including configuring at least one of the entities to operate in a different way to the pre-existing communications protocols.

It is thus possible to optimise and/or improve a communications scheme. This should be contrasted with merely identifying which one(s) of pre-existing communications protocols are supported in a communications chain and picking one of them. The present invention reduces the number of computationally redundant actions.

The capabilities of the entities may be determined by interrogating them or by reference to a library detailing the capabilities of the entities, or by a mixture of these approaches.

Preferably the communications scheme is defined automatically by a scheme controller which analyses the capabilities of the various entities within the data exchange path.

The entities may be hardware devices, or software applications or a mixture of both.

Devices in the communications path between the target and source devices (which themselves do not need to be at the ends on the path) can be considered as interstitial or intermediate entities.

The scheme controller may perform local optimisation, where it seeks to define local communication schemes that optimise the performance of two or more neighbouring entities in the data pathway, but where such optimisation is still based on a knowledge of the entire data pathway. Alternatively, the scheme controller may seek to perform a global optimisation of the data path.

Advantageously the scheme controller builds the devised communication scheme into compiled computer code in order to minimise computational work load on each data processing device that is participating in the data transfer. Compiled code, that is directly executable code, rather than interpreted code is much faster during execution.

Almost inevitably one or two entities in the data path will have performance issues which cause them to be the major rate limiting entities in the data path. Thus the communication scheme controller can achieve the most immediate system improvement by analysing the capabilities of the rate limiting devices and their near neighbours in the data pathway. Alternatively, the compiler may seek to achieve a global optimisation for the data pathway. This is more likely to be computationally complex but can confer significant benefits.

Preferably the scheme controller looks for redundant data translation steps. It is surprisingly common for one device in the data scheme to handle its internal calculations in one format, for example big-endian or little-endian, to convert this into a different format so as to comply with the data exchange protocol, only for the device receiving the data to perform a further data translation to convert the data back into the format it was originally in. These redundant data translation steps are clearly computationally wasteful.

The scheme controller also looks to remove other redundant steps in the scheme. Thus, for example encryption and decryption processes which may be necessary to ensure integrity of transmission across a public communication network or via the internet, are rendered unnecessary when communication occurs across a secure communication channel.

The communication scheme thus is a combination or protocols used and other data translation steps.

Advantageously the scheme controller has access to one or more libraries of protocols which are or could be supported by devices in the communication path. Thus, the scheme controller has the option to introduce a new protocol to one or more devices which have previously not supported the protocol.

Advantageously, where devices within the data pathway can handle a number of protocols, the communications controller seeks to identify which protocol is the most commonly supported, and thereby to use that protocol so as to minimise the number of translation steps necessary.

According to a second aspect of the present invention, there is provided a communications and/or data processing system using a method according to the first aspect of the present invention.

The present invention will further be described, by way of example, with reference to the accompanying drawings, in which:

FIG. 1 schematically illustrates a data processing system;

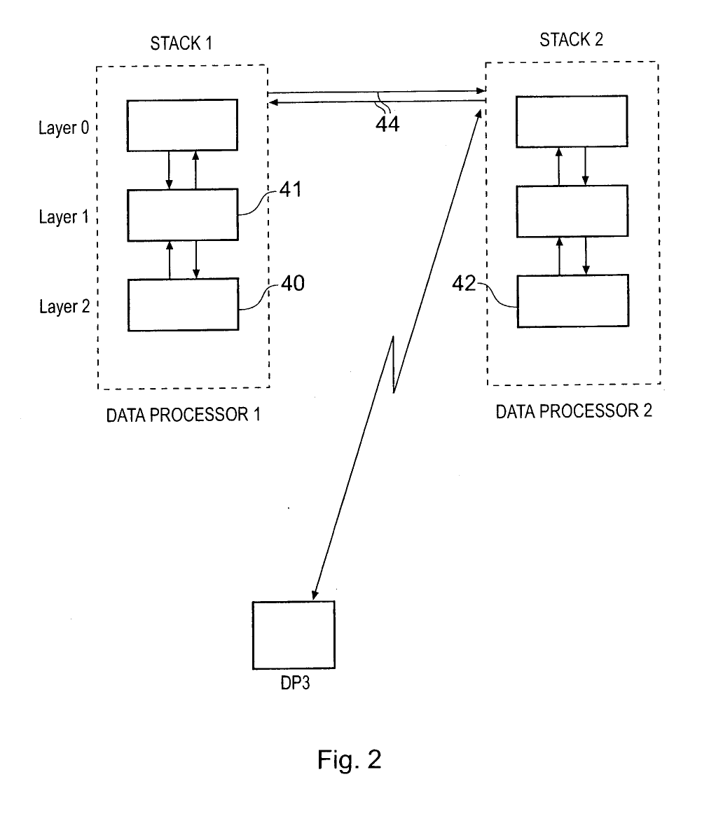

FIG. 2 schematically illustrates a layered device structure; and

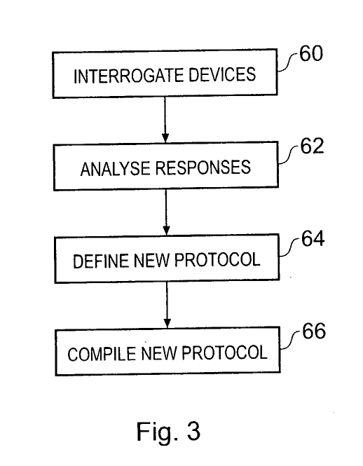

FIG. 3 schematically illustrates the processing steps performed in an embodiment of the present invention.

Typically, communications between devices involve many translations of information to correspond to protocols defined for those devices. The well known architecture for the inter working of devices is the ISO Layer structure defined by the International Standards Organisation with the open systems interconnection (OSI) presentation. This ISO/OSI Layer structure contains 7 layers, each of which represents an entity which performs its functions and tasks. Each layer can be regarded as a logical block thus, one layer may represent the communications switching performed at the Internet service provider 14 and 18 shown in FIG. 1. A subsidiary layer may be represented by the servers and so on. Each logical block has its own functions, tasks or assignments and has its own tools for executing its tasks. These tools consist of the protocols that allow the block in any given layer to communicate with peer blocks, that is to say blocks in the same layer. These protocols are called peer-to-peer protocols. Each layer could also communicate with the vertically adjacent layer. In order to do this the protocol contains functions and conventions that describe how to use its own functions and those provided by the next layer, and also contains the rules for providing notifications (known as primitives) which pass instructions from one layer to an adjacent layer.

FIG. 2 illustrates such a layered structure thus, if a device 40 in stack 1, layer 2 which may for example be within a first data processor, data processor 1, wishes to communicate with a device 42, also in layer 2 but in stack 2 for example in a second data processor, data processor 2, it could talk directly to the device if there was a data pathway occurring in layer 2. However, in the arrangement shown in FIG. 2 the only data pathway inter connecting stack 1 and stack 2 occurs at layer 0. Thus the information which the device 40 wishes to transmit has to be passed from layer 2 in stack 1 to layer 1 of stack 1 and finally to layer 0 of stack 1. Each data exchange may involve a translation of the data in order to conform to the protocols used within each of the layers 1 and 0. Once the data has reached layer 0, it could be transferred to stack 2 via a communications pathway 44. Once the data has reached stack 2, it is there propagated down from layer 0, to layer 1 and finally to layer 2 of stack 2. Each of these propagations may again involve data translation in order to correspond to the protocols. Even if the data remains essentially unchanged, additional data describing the data that is to be transferred will probably be generated and passed from layer to layer and protocol to protocol in order to ensure proper functioning of the system. Thus, it can be seen that a great deal of computational power is wasted in merely conforming with the protocol exchanges in order to operate within such a stack.

In the present invention, once the need to define a data pathway between blocks 40 and 42 via communications link 44 has been identified, a data path controller collates data concerning each of the elements in the path in order to seek to minimise unnecessary data translations and/or to use the various immediate protocols in such a way which minimises the computational load and/or maximises data transfer rate.

Supposing the communication system disclosed in FIG. 2 is that of a server and a client, and it is desired to establish communication between the server and the client. They can communicate using the complete TCP/IP stack. This means that both ends may exploit symbolic representations of how the connections are established between them. Typically the client will connect to a socket on the server via a TCP/IP socket service within its own operating system.

At this point at both ends we can have:

Client:

Application->Socket Server->OS level 1->OS level 2->. . . ->OS level k->DLL 1->DLL n->Driver->Hardware

Server:

Source->Socket Server->OS level 1->OS level 2->. . . ->OS level m->DLL 1->DLL n->Driver->Hardware

Where OS stands for operating system

Typically at each level the data gains a small amount of “wrapper”, that is additional data which enables the layers in the lists to ignore details of the layers to their right. Once the client and server have established a connection and know how they exchange data then it is possible to encode all of the layers as follows:

Client:

Application->Hardware

Server:

Application->Hardware

Thus a typical communication path requires:

1) The establishment of a socket server.

2) The socket server uses the operating system (OS) to determine underlying socket types (an abstraction)

3) The sockets require a buffering service provided by OS

4) The sockets require a scheduling service provided by OS

5) Data passing through sockets is broken into packets

6) The packet breaker needs buffering provided by OS

7) The packet breaker needs scheduling provided by OS

8) The packets are moved to the link library supplied by hardware vendor (possibly layered)

9) The packets are moved to the hardware for transport.

The above scheme permits the final application a very simple view of system function, but at the cost of having the data transferred or operated on many times.

Thus, as shown in FIG. 3, a data scheme controller, which may be implemented within any one of the data processors within the data communications path or by an external data processor DP3 (FIG. 2) which is contacted by the system over a communication path 50 in order to perform the analysis, interrogates the entities or devices in the communications path (step 60) and analyses the responses (step 62). The data processor then collates data concerning each of the entities in the path. This may either be from analysis of a library which already contains data concerning the entities or devices, or by interrogating each entity or device that is discovered in the path. Once data concerning the devices has been received, it is then analysed. The data may define the current achievable speeds on physical connections to and from the device, processing power and internal storage availability, and a list of protocols supported by the device. The data may also include a list of “plug-ins” which can be executed in the device which may enable the device to handle data in certain specific formats, and the processing overhead incurred in using such a format.

Having received this information, the scheme controller then analyses the information in order to define a new communications scheme (step 64) which may comprise instructing devices to work with existing communications protocols, or may result in the derivation of new hybrid protocols to be implemented by the devices. In this context, hybrid protocols may be built from library blocks which are used in standard protocols, but where data transformations which have been identified as being redundant are omitted. Once the new and/or revised protocols are defined these are then compiled (step 66) by the communications scheme controller and downloaded to the various devices in the communications network. Alternatively, rather than compiling the new protocols at the controller and downloading them to the various devices, the controller may download instructions to subsidiary compilers which are located within the devices in the communications network such that they can locally compile a revised protocol and then implement it. This scheme has the advantage in that the amount of data exchange across the network is reduced, albeit at the expense of increased computational load in those devices which have to recompile a new protocol.

A simple example of the optimisation mechanism through XML is the case of validation through public keys. A document exchange that occurs via a non trusted channel (e.g. the Internet) needs to make use of a public key system (or some such equivalent system) to facilitate exchange of the document whilst preventing its contents from becoming public. A typical XML procedure might read as follows:

| <Locate> | | (start of routine) |
|---|---|---|
| | <Query> | (start of query procedure) |

| | |
|---|---|
| <ds:KeyInfo> | (start of procedure to obtain |
| | public key) |

| | |
|---|---|
| <ds:RetrievalMethod | (start of retrieval method) |

URI=“http://www.PKeyDir.Shimano/certificates/
01293122” (data for retrieval)
Type=“http://www.campagnolo.com/2000/09/
xmldsig#X509Data”/>

| | |
|---|---|
| </ds:KeyInfo> | (end of procedure to obtain public key) |

| | |
|---|---|
| </Query> | (end of query procedure) |

<Respond>

<string>KeyName</string>
<string>KeyValue</string>

</Respond>

</Locate>

When the same exchange occurs over a trusted network (e.g. a firms Intranet), the optimisation in this case simply involves the removal of the public key method—even the nullification of the body.

<Locate>

</Locate>

This is not the same as encoding within the XML some mechanism for detecting the status of the message system (an if-then-else). It is an external optimisation, driven by external policy, and through knowledge of the data path, as determined by the communication scheme controller

Thus, automatic optimisation of complex processes can be performed by virtue of looking for effectively redundant or unnecessary processing steps, and by varying communication strategies so as to reduce processing overheads and/or to better match them to network capabilities.

1. A method of transferring data between a source entity and a target entity via a data pathway, each entity having a hierarchy of communication processing layers implementing at least one communications protocol, the method comprising the steps of determining the capabilities of the entities, analysing the capabilities of the entities, and on the basis of those capabilities establishing a communication scheme including configuring at least one of the entities to operate in a different way to the pre-existing communications protocols.

2. A method as claimed in claim 1, wherein at least one interstitial entity is located in the data pathway between the source entity and the target entity, and in which the capabilities of the at least one interstitial entity are determined and considered during the analysis of the entities.

3. A method as claimed in claim 2, in which at least one interstitial entity is configured to operate in a different way.

4. A method as claimed in claim 1, in which the hierarchy of communications layers within an entity are caused to operate differently.

5. A method as claimed in claim 1, in which the reconfigured entity is reconfigured to operate in a way so as to remove redundancy within the data path.

6. A method as claimed in claim 1, in which the entities within the communications path exchange data concerning their capabilities such that at least one data processor can analyse the information to define a communication scheme.

7. A method as claimed in claim 6, in which at least one data processor uses the data available to compile a new communications protocol for the transfer of data.

8. A method as claimed in claim 7, in which a new protocol is complied within each individual interstitial entity in the communication path.

9. A method as claimed in claim 6, in which the data processor determines if the communication scheme would be improved by a change of protocol in one or more of the entities which could support the changed protocol even if the entity does not have the protocol immediately available, but such a protocol exists, and if so the data processor obtains the protocol from a source thereof and incorporates it into the communication scheme.

10. A method as claimed in claim 9, where the data processor derives a plurality of communications schemes, and then analyses them to determine the best one.

11. A method as claimed in claim 6, in which the data processor is one of the entities in the communications path.

12. A method as claimed in claim 6, in which the data processor analysing the communication scheme is not one of the data processors involved in the communications path.

13. A method as claimed in claim 1 in which the communications scheme is compiled before use.

14. A method as claimed in claim 1, in which the communications scheme is run in an interpreted mode.

15. A method as claimed in claim 1, in which at least one of the entities is a hardware device.

16. A method as claimed in claim 1, in which at least one of the entities is an item of software.

17. A method as claimed in claim 1, in which the capabilities of an entity are determined by interrogating the entity

18. A method as claimed in claim 1, in which the capabilities of an entity are determined by looking them up.

19. A computer program product for causing a data processor to execute the method as claimed in any one of claims 1 to 18.

20. A communication scheme controller for controlling the transfer of data, the controller arranged to interrogate the entities included in the transfer of data between a source entity and a target entity so as to determine their capabilities, to analyse the responses and to define a communication scheme for data transfer.

21. A communication scheme controller as claimed in claim 20, in which the controller devices a communication scheme and sends on appropriate part of it to the or each entity in the communications path.

22. A method of transferring data between entities; the method comprising the steps of interrogating the entities involved in the transfer of data between a source entity and a target entity so as to determine their capabilities, analysing the responses, and on the basis of those responses defining a communication scheme for data transfer, in which computing devices within the communications path exchange data concerning their capabilities such that at least one data processor can analyse the information to define a communication scheme, and the at least one data processor uses the data available to compile a new communications protocol for the transfer of data.

23. A method as claimed in claim 22, in which a new protocol is complied within each individual hardware device in the communication path.

24. A method as claimed in claim 22, in which the data processor determines if the communication scheme would be improved by a change of protocol in one or more of the entities which could support the changed protocol even if the entity does not have the protocol immediately available, but such a protocol exists, and if so the data processor obtains the protocol from a source thereof and incorporates it into the communication scheme.

25. A method of transferring data between source and target entities via a communications path including at least one intermediate entity, each entity having a hierarchy of communication processing layers implementing at least one communication protocol, the method comprising the steps of collecting data relating to the capability of at least the at least one intermediate entity; establishing a scheme for transferring data including configuring at least one intermediate entity's hierarchy to cause it to operate differently on data passing along the pathway.

26. A method as claimed in claim 25, in which the capabilities of the source and target entities are determined.

27. A method as claimed in claim 25, in which computing entities within the communications path exchange data concerning their capabilities such that at least one data processor can analyse the information to define a communication scheme.

28. A method as claimed in claim 27, in which at least one data processor uses the data available to compile a new communications protocol for the transfer of data.

29. A method as claimed in claim 27, in which the data processor determine if the communication scheme would be improved by a change of protocol in one or more of the entities which could support the changed protocol even if the entity does not have the protocol immediately available, but such a protocol exists, and if so the data processor obtains the protocol from a source thereof and incorporates it into the communication scheme.

30. A method as claimed in claim 29, where the data processor derives a plurality of communications schemes, and then analyses them to determine the best one.

31. A method as claimed in claim 30 in which the communications scheme is compiled before use.
